(19) United States
(12) Patent Application Publication
(10) Pub. No.: US 2020/0139179 A1
(43) Pub. Date: May 7, 2020

(54) METHOD AND SYSTEM FOR SUPPRESSING FIRES IN BUILDINGS

(71) Applicant: GENEMAR GLOBAL LLC, AURORA, OH (US)

(72) Inventor: EUGENE J. ALLEN, JR., AURORA, OH (US)

(21) Appl. No.: 16/670,416

(22) Filed: Oct. 31, 2019

Related U.S. Application Data
(60) Provisional application No. 62/754,201, filed on Nov. 1, 2018.

(51) Int. Cl. A62C 99/00; A62C 37/44

(52) U.S. Cl. CPC A62C 99/0018; A62C 37/44

(57) ABSTRACT

A system is provided that relates to fire suppression in a building. This system utilizes ductwork and the heating, ventilation, and air conditioning (HVAC) system of the building to introduce Nitrogen (N₂) into the building in order to deplete the concentration of Oxygen (O₂) within the building's internal atmosphere and suppress a fire. A central control unit (CCU) can monitor N₂ and/or O₂ levels within the building and control the supply of N₂ into the building to suppress the fire while maintaining the air at an acceptable level of O₂ for any building occupants to breathe.

### CROSS-REFERENCE TO RELATED APPLICATIONS

This application claims the benefit of U.S. Provisional Application No. 62/754,201, filed Nov. 1, 2018 and entitled METHOD AND SYSTEMS FOR SUPPRESSING FIRES IN A BUILDING. The entirety of the aforementioned application is incorporated herein by reference.

### TECHNICAL FIELD

Embodiments of the subject matter disclosed herein relate to a fire suppression system for use in buildings.

### DISCUSSION OF ART

The logistics of fighting high rise building fires can be very difficult and expensive. These difficulties can be due to requiring special fire-fighting equipment, lack of water availability and pressure, and because access to entrances or exits are often blocked. There is tremendous risk for loss of life, property, equipment, data, records and collateral damage to neighboring offices, apartments and buildings. Not only is destruction caused directly from the flames but also from smoke, water damage and building collapse.

Firemen and building occupants are in constant danger from all of the factors above in the case of a fire. It may be desirable to have a system and method for suppressing fires within buildings.

### BRIEF DESCRIPTION

In an embodiment, a system is provided that includes an HVAC system including an air intake and an air outlet connected to ductwork, a nitrogen supply connected to at least one of the air intake, the air outlet, or the ductwork at one or more injection points, at least one oxygen sensor located downstream from at least one of the injection points, and a controller configured to: receive an oxygen concentration value from the at least one oxygen sensor; compare the oxygen concentration value to an oxygen concentration set point; and control at least one of a pressure, volume, flow rate, or duration of injection of nitrogen from the nitrogen supply to the one or more injection points based on the oxygen concentration value.

In an embodiment, a method includes supplying a flow of nitrogen into an HVAC system of the building; receiving an oxygen concentration value from at least one oxygen sensor; comparing the oxygen concentration value to an oxygen concentration set point; and controlling at least one of a pressure, volume, flow rate, or duration of injection of nitrogen from a nitrogen supply to the HVAC system through one or more injection points to control the oxygen concentration level towards the oxygen concentration set point.

In an embodiment, a fire suppression system for a building includes an HVAC system that includes an air intake and an air outlet connected to ductwork; a nitrogen supply; and a nitrogen supply conduit connected to the nitrogen supply at a first end, and connected to the ductwork at a second end at one or more injection points. A nitrogen flow through each of the one or more injection points is independently controllable.

### BRIEF DESCRIPTION OF THE DRAWINGS

Reference is made to the accompanying drawings in which particular embodiments and further benefits of the subject innovation are illustrated as described in more detail in the description below, in which:

FIG. 1 is a chart displaying fuel, nitrogen, and oxygen ratios contributing towards flammable mixtures;

FIG. 2 is a block diagram of an embodiment of the fire suppression system;

FIG. 3 is a block diagram of another embodiment of the fire suppression system;

FIG. 4 is a block diagram of the central control unit's interactions with components of the fire suppression system;

### DETAILED DESCRIPTION OF THE INVENTION

Embodiments of the innovation relate to methods and systems for fire suppression in a building. This system utilizes ductwork and the heating, ventilation, and air conditioning (HVAC) system of the building to introduce Nitrogen (N₂) into the building in order to deplete the concentration of Oxygen (O₂) within the building's internal atmosphere and suppress a fire. A central control unit (CCU) can monitor N₂ and/or O₂ levels within the building and control the supply of N₂ into the building to suppress the fire while maintaining the air at an acceptable level of O₂ for any building occupants to breathe. With reference to the drawings, like reference numerals designate identical or corresponding parts throughout the several views. However, the inclusion of like elements in different views does not mean a given embodiment necessarily includes such elements or that all embodiments of the invention include such elements.

The term “component” as used herein can be defined as a portion of hardware, a portion of software, or a combination thereof. A portion of hardware can include at least a processor and a portion of memory, wherein the memory includes an instruction to execute.

The fire suppression system 100 utilizes ductwork and a building's HVAC system to employ industrial fire suppression techniques which use inert gases such as nitrogen (N₂) to suppress fires and explosion. In our atmosphere on Earth, N₂ represents 78+% of air, it is inert and non-toxic. The remaining components of air are oxygen (O₂), which makes up 21% of air, and the residual 1% consists of argon and the rare gases (neon, xenon and krypton) which are also inert. N₂ gas can be generated on demand, in-situ and does not require a water supply, chemicals or elaborate fire-fighting equipment to implement. N₂ can be supplied by vaporizing liquid N₂ from a cryogenic storage tank (truck delivery) or by generating N₂ gas via a membrane system either located on the premises or brought in by truck. The membrane can utilize electric power from the grid or via electric generator to generate the N₂.

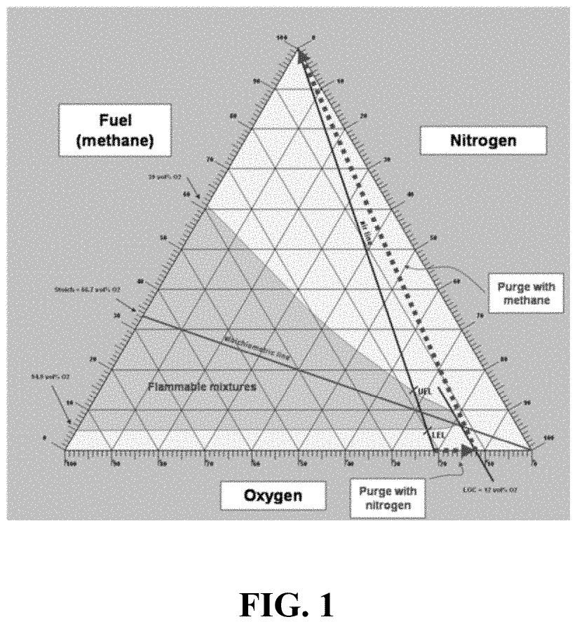

In any fire there is a combination of fuel, oxygen (O₂) and temperature which supports the combustion process as displayed by the chart in FIG. 1. By reducing the O₂ concentration in the air to a level below what is required for combustion, via the injection of N₂ gas, the fire is abated and eventually suppressed. The results are very rapid and often quick enough that explosion can be avoided.

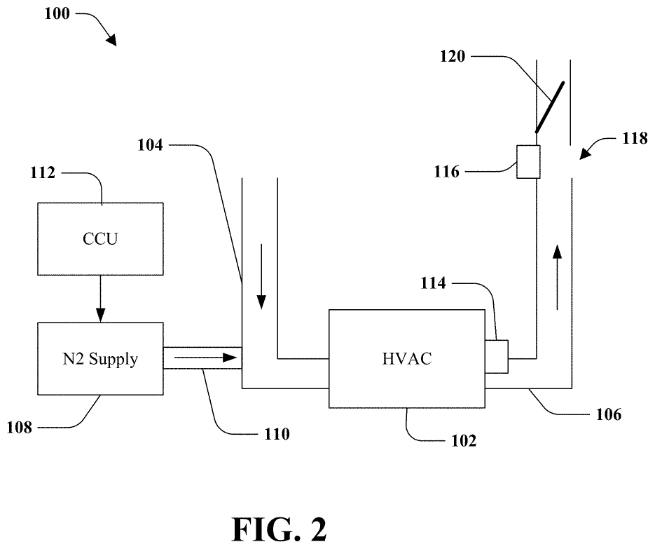

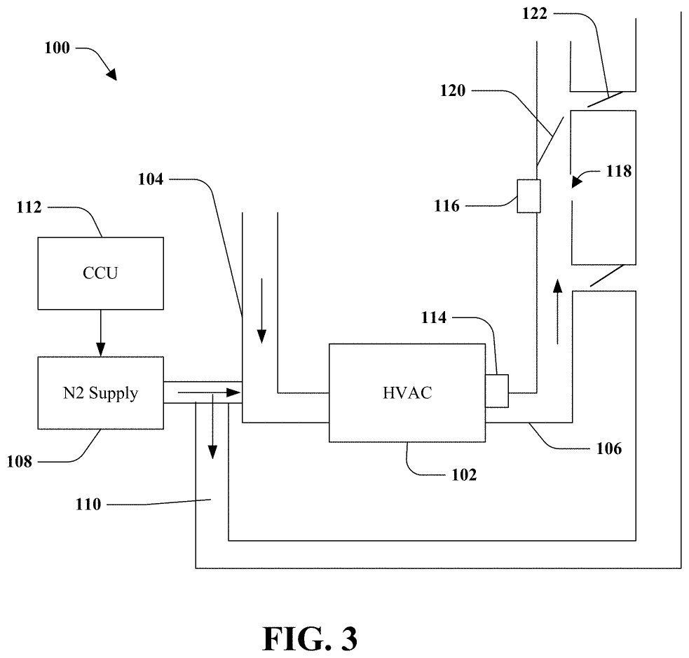

Turning now to FIG. 2, the fire suppression system 100 can include an HVAC system 102 having an air intake 104 and an air outlet 106 that supplies air to ductwork throughout the building. The fire suppression system 100 also includes an N₂ supply 108 connected to at least one of the air intake 104 or the air outlet 106 of the HVAC system 102 by a N₂ supply conduit 110. In certain embodiments, the N₂ supply 108 is connected to the air intake 104 and/or the air outlet 106 in multiple locations as shown in FIG. 3. In certain embodiments, a series of nozzles or injectors are inserted into the ductwork at one or more locations either upstream or downstream of the HVAC system 102. The N₂ supply conduit can be piping (e.g. made from PVC, plastic or metal), or typical ductwork such as metallic ductwork. The N₂ supply 108 can be located outside of the building, and can be either a bulk liquid nitrogen storage tank and vaporizer, an on-site N₂ gas generation system, or a combination of both. A gas generation system can be, for example, a membrane unit or pressure swing adsorption unit. The gas generation system can be powered by its own power supply, or it can be powered from the power grid.

A central control unit (CCU) 112 controls the supply of N₂ from the N₂ supply 108 into the HVAC system 102 or ductwork and also monitors O₂ concentration levels provided by one or more O₂ sensors located along the ductwork throughout the building. In applying this technique to fire fighting in homes, office buildings or factories, the fire suppression system 100 would inject N₂ gas into the air intake 102 of the HVAC system 102 and reduce the O₂ level of the internal building atmosphere below, or near, the threshold below which combustion is impossible. This level depends on the fuel source of the fire. This O₂ level in a typical building fire is around 10%. In certain embodiments, the injection of N₂ into the ductwork can be at a high enough pressure (greater than the outside atmospheric pressure) to displace oxygen even if the fire causes the inside of the building to be exposed to the outside environment.

The O₂ level can be monitored in the ductwork of the HVAC system both immediately following the exit from the HVAC system 102 and also in each space in which the normal HVAC air would be supplied. An outlet sensor 114 can be installed at the air outlet 106 of the HVAC system 102. The outlet sensor 114 can monitor the O₂ concentration at a point immediately following the exit from the HVAC system 102. Further, there can be one or more room sensors 116 installed in the ductwork at vents or openings 118 to provide an oxygen concentration reading that corresponds to individual rooms. In another embodiment, the room sensor 116 can be located inside the room itself rather than within the ductwork.

The CCU 112 is a controller that is configured to regulate at least one of the pressure, volume, flow rate, or duration of N₂ injection into the fire suppression system 100. The CCU 112 can control N₂ injection by controlling the N₂ supply directly, or it may operate one or more control valves or pumps that control flow of the N₂ out of the N₂ supply. The CCU 112 can communicate with each of the outlet sensor 114 and the room sensors 116 to obtain an oxygen concentration value. The oxygen concentration value can be chosen to be an average of one or more of the sensors, an oxygen concentration value of a particular room sensor, or an average of one or more of the room sensors. Communication between the CCU 112 and the sensors can be either wired or wireless. Wireless communications can use any appropriate protocol such as Wi-Fi, Bluetooth, Zigbee, 3G, 4G, or 5G mobile communications, among others. The CCU 112 can adjust the pressure, volume, flow rate, or duration of N₂ injection in order to reach an oxygen concentration set point. This set point can be user configurable. In certain embodiments, the CCU 112 can have a user interface (e.g. touch screen, pushbuttons, etc.) to configure the fire suppression system 100 or modify settings such as the set point value.

In certain embodiments, the CCU 112 can be configured to isolate the flow of the N₂ stream to a particular area of the building where the fire is located. This can be accomplished by operation of one or more dampers 120 that can be operated to open or restrict flow through certain portions of the ductwork. It should be appreciated that the term “damper” as used herein can refer to a movable plate, or it can also refer to any type of device that can control or restrict a flow of gas (e.g. a valve). For example, if there is a fire isolated to the room associated with opening 118, the CCU 112 can command the damper 120 to close, thus directing all of the N₂ flow into that room. In another example, the N₂ stream can be selectively injected with only certain nozzles. If the N₂ supply is connected with the ductwork at multiple locations as shown in FIG. 3, the CCU 112 can activate or deactivate certain injection nozzles to control where and to what rooms the N₂ is being delivered. The CCU 112 can activate or deactivate certain injection points or nozzles by controlling one or more nitrogen dampers 122 to control the N₂ flow into different points of the HVAC ductwork.

In certain embodiments, the CCU 112 can be controlled or operated remotely. For example, a user can operate the CCU 112 using a mobile device 124 such as a smartphone, a dedicated remote control, a computer, a laptop, a tablet, or a voice controlled device. The user can operate the CCU 112 with the mobile device 124 to isolate N₂ flows to a specific floor, room, or group of rooms. The user can also operate the CCU 112 with the mobile device 124 to manually control at least one of the pressure, volume, flow rate, or duration of N₂ injection into the fire suppression system 100 or two change the O₂ concentration set point value. For example, a firefighter involved in fighting an ongoing fire within a building can use the mobile device 124 to isolate the N₂ flow into a specific room after receiving visual confirmation that the fire is isolated to that room.

In certain embodiments, the operation of the fire suppression system can occur automatically. For example, if a fire detector detects a fire in the building, the detector can communicate with the fire suppression system to instruct the CCU 112 to begin the fire suppression operation. In one embodiment, a fire detector in the building can detect a fire in a particular room. The fire detector can communicate with the fire suppression system to instruct the CCU 112 to begin the fire suppression operation and to isolate the nitrogen flow into the particular room.

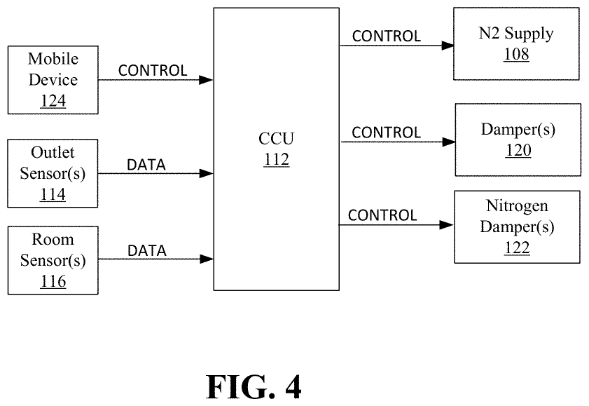

Turning now to FIG. 4, the CCU's 112 interactions with the fire suppression system components are summarized. The CCU 112 can receive data signals from the outlet sensor 114 and/or the room sensors 116. These data signals represent feedback of at least one of an O₂ concentration value or a N₂ concentration value. The CCU 112 can compare these values or an average of these values to a set point value and dynamically control the N₂ supply 108 accordingly to achieve the set point value. By way of example and not limitation, the CCU 112 can operate as a proportional-integral-derivative (PID) controller, a proportional-integral (PI) controller or a proportional (P) controller. The CCU 112 can also transmit control signals to the dampers 120 or the nitrogen dampers 122 to isolate N₂ injection or delivery into a particular area of the building. The CCU 112 can also receive a remote control signal from the mobile device 124 as described above.

The office building, factory or home environment may very well have human life present where the fire is active. This creates a problem since there is a minimum level of O₂ in air required for human respiration below which injury or death may occur. Unconsciousness in cases of accidental asphyxia can occur within 1 minute. Loss of consciousness results from critical hypoxia, when arterial oxygen saturation is less than 60%. At oxygen concentrations of 12-15%, a person would experience poor judgment, faulty coordination, and excessive fatigue upon exertion. At oxygen concentrations of 10-12%, a person would experience very poor judgment and coordination, impaired respiration that may cause permanent heart damage, possibility of fainting within a few minutes without warning, and nausea and vomiting. At oxygen concentrations of less than 10%, a person would experience inability to move, loss of consciousness, convulsions, and death. At oxygen concentrations of 4 to 6%, there is loss of consciousness in 40 seconds and death within a few minutes.

Therefore, control of the oxygen concentration in the air of the building should be maintained at least at or slightly above the 10% level for full implementation of the process. However, it may be desirable in certain embodiments to maintain the oxygen concentration within a level between 12-15%. Maintaining the oxygen concentration within this 12-15% range would offer significant fire suppression benefits, but would also provide adequate oxygen for any occupants remaining inside the building. Providing the nitrogen at a rate to maintain the oxygen within the 12-15% range enables fire fighters to enter buildings under less extreme conditions as compared to a building having a normal atmospheric level of oxygen concentration in the air.

In an embodiment, a system is provided that includes an HVAC system including an air intake and an air outlet connected to ductwork, a nitrogen supply connected to at least one of the air intake, the air outlet, or the ductwork at one or more injection points, at least one oxygen sensor located downstream from at least one of the injection points, and a controller configured to: receive an oxygen concentration value from the at least one oxygen sensor; compare the oxygen concentration value to an oxygen concentration set point; and control at least one of a pressure, volume, flow rate, or duration of injection of nitrogen from the nitrogen supply to the one or more injection points based on the oxygen concentration value.

In one embodiment, the fire suppression system further includes one or more dampers located within the ductwork, wherein the controller is further configured to control the one or more dampers based on the oxygen concentration value.

In one embodiment, the fire suppression system further includes a nitrogen supply conduit connected to the nitrogen supply at a first end and connected to the ductwork at a second end at the one or more injection points.

In one embodiment, the fire suppression system further includes one or more nitrogen dampers located within the nitrogen supply conduit.

In one embodiment, the controller is further configured to control the one or more nitrogen dampers based on the oxygen concentration value.

In one embodiment, the one or more oxygen sensors comprises a room sensor corresponding to a room of the building, and the controller is further configured to control the at least one of the pressure, volume, flow rate, or duration of injection of nitrogen from the nitrogen supply to an injection point of the one or more injection points, wherein the injection point corresponds to the room.

In one embodiment, the fire suppression system further includes a mobile device configured to communicate with the controller to provide a control input.

In one embodiment, the mobile device is configured to provide the control input to the controller to cause the controller to control at least one of the pressure, volume, flow rate, or duration of injection of nitrogen from the nitrogen supply to the one or more injection points.

In one embodiment, the mobile device is configured to provide the control input to the controller to cause the controller to isolate nitrogen flow into a room or area of the building.

In one embodiment, the controller is configured to control the oxygen concentration level towards the oxygen concentration setpoint.

In one embodiment, the oxygen concentration setpoint is greater than or equal to 10%.

In one embodiment, the oxygen concentration setpoint is a range of 12% to 15%.

In one embodiment, the nitrogen supply is a tank containing nitrogen.

In one embodiment, the nitrogen supply is a nitrogen generating system.

In one embodiment, the nitrogen generating system is a membrane system.

In one embodiment, the oxygen concentration value is an average value from multiple oxygen sensors.

In one embodiment, the oxygen concentration value corresponds to a particular room.

In an embodiment, a method includes supplying a flow of nitrogen into an HVAC system of the building; receiving an oxygen concentration value from at least one oxygen sensor; comparing the oxygen concentration value to an oxygen concentration set point; and controlling at least one of a pressure, volume, flow rate, or duration of injection of nitrogen from a nitrogen supply to the HVAC system through one or more injection points to control the oxygen concentration level towards the oxygen concentration set point.

In one embodiment, the method further includes controlling one or more dampers to control the oxygen concentration level towards the oxygen concentration set point.

In an embodiment, a fire suppression system for a building includes an HVAC system that includes an air intake and an air outlet connected to ductwork; a nitrogen supply; and a nitrogen supply conduit connected to the nitrogen supply at a first end, and connected to the ductwork at a second end at one or more injection points. A nitrogen flow through each of the one or more injection points is independently controllable.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using a devices or systems and performing incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A fire suppression system for a building, comprising:
an HVAC system comprising an air intake and an air outlet connected to ductwork;
a nitrogen supply connected to at least one of the air intake, the air outlet, or the ductwork at one or more injection points;
at least one oxygen sensor located downstream from at least one of the injection points; and
a controller configured to:
receive an oxygen concentration value from the at least one oxygen sensor;
compare the oxygen concentration value to an oxygen concentration set point; and
control at least one of a pressure, volume, flow rate, or duration of injection of nitrogen from the nitrogen supply to the one or more injection points based on the oxygen concentration value.

2. The fire suppression system of claim 1, further comprising:
one or more dampers located within the ductwork, wherein the controller is further configured to control the one or more dampers based on the oxygen concentration value.

3. The fire suppression system of claim 1, further comprising:
a nitrogen supply conduit connected to the nitrogen supply at a first end and connected to the ductwork at a second end at the one or more injection points.

4. The fire suppression system of claim 3, further comprising:
one or more nitrogen dampers located within the nitrogen supply conduit.

5. The fire suppression system of claim 4, wherein the controller is further configured to control the one or more nitrogen dampers based on the oxygen concentration value.

6. The fire suppression system of claim 1, wherein the one or more oxygen sensors comprises a room sensor corresponding to a room of the building, and the controller is further configured to control the at least one of the pressure, volume, flow rate, or duration of injection of nitrogen from the nitrogen supply to an injection point of the one or more injection points, wherein the injection point corresponds to the room.

7. The fire suppression system of claim 1, further comprising:
a mobile device configured to communicate with the controller to provide a control input.

8. The fire suppression system of claim 7, wherein the mobile device is configured to provide the control input to the controller to cause the controller to control at least one of the pressure, volume, flow rate, or duration of injection of nitrogen from the nitrogen supply to the one or more injection points.

9. The fire suppression system of claim 7, wherein the mobile device is configured to provide the control input to the controller to cause the controller to isolate nitrogen flow into a room or area of the building.

10. The fire suppression system of claim 1, wherein the controller is configured to control the oxygen concentration level towards the oxygen concentration set point.

11. The fire suppression system of claim 10, wherein the oxygen concentration set point is greater than or equal to 10%.

12. The fire suppression system of claim 10, wherein the oxygen concentration set point is a range of 12% to 15%.

13. The fire suppression system of claim 1, wherein the nitrogen supply is a tank containing nitrogen.

14. The fire suppression system of claim 1, wherein the nitrogen supply is a nitrogen generating system.

15. The fire suppression system of claim 14, wherein the nitrogen generating system is a membrane system.

16. The fire suppression system of claim 1, wherein the oxygen concentration value is an average value from multiple oxygen sensors.

17. The fire suppression system of claim 1, wherein the oxygen concentration value corresponds to a particular room.

18. A method of suppressing a fire in a building, comprising:
supplying a flow of nitrogen into an HVAC system of the building;
receiving an oxygen concentration value from at least one oxygen sensor;
comparing the oxygen concentration value to an oxygen concentration set point; and
controlling at least one of a pressure, volume, flow rate, or duration of injection of nitrogen from a nitrogen supply to the HVAC system through one or more injection points to control the oxygen concentration level towards the oxygen concentration set point.

19. The method of claim 18, further comprising:
controlling one or more dampers to control the oxygen concentration level towards the oxygen concentration set point.

20. A fire suppression system for a building, comprising:
an HVAC system comprising an air intake and an air outlet connected to ductwork;
a nitrogen supply; and
a nitrogen supply conduit connected to the nitrogen supply at a first end, and connected to the ductwork at a second end at one or more injection points, wherein a nitrogen flow through each of the one or more injection points is independently controllable.
